(19) United States
(12) Patent Application Publication
(10) Pub. No.: US 2013/0004801 A1
(43) Pub. Date: Jan. 3, 2013

(54) REACTOR, SYSTEM AND METHOD FOR SOLID REACTANT BASED THERMOCHEMICAL PROCESSES

(76) Inventor: Asegun Henry, Atlanta, GA (US)

(21) Appl. No.: 13/538,304

(22) Filed: Jun. 29, 2012

Related U.S. Application Data
(60) Provisional application No. 61/503,723, filed on Jul. 1, 2011.

(51) Int. Cl. C01B 3/06; F03G 6/00; H01M 16/00

(52) U.S. Cl. 429/9; 423/657; 422/162; 60/641.8

(57) ABSTRACT

A method and system for solid reactant based thermochemical process are disclosed. A metal oxide or solid reactant having a crystal structure associated with a characteristic state of high temperature engendering creation of oxygen vacancies is identified. The metal oxide is heated to the high temperature corresponding to the state of oxygen vacancies. Subsequently, the solid reactant is cooled to a temperature conducive to water splitting reaction. Steam is then introduced to react with the solid reactant to thereby re-oxidize the solid reactant producing hydrogen gas. Finally, the re-oxidized solid reactant is reheated to a reduction temperature completing the process of solid based reactant thermochemical solar power generation.

The system includes one or more processors adapted to configure a solar absorption system, a thermochemical system, a gas storage system for storing product gases and a power generation system for processing the stored product gases into electrical power.

### CROSS REFERENCE TO RELATED APPLICATIONS

This patent application claims priority to U.S. Provisional Patent Application Ser. No. 61/503,723, entitled VIRTUAL SPECTRUM AGGREGATION, filed Jul. 1, 2011, which is herein incorporated by reference in its entirety.

### FIELD OF THE INVENTION

The present invention relates to the technical field of thermochemical engineering. More particularly, the present invention relates to the technical field of thermochemical energy conversion.

### BACKGROUND OF THE INVENTION

Current solar thermochemical reactor designs involve direct irradiation of the solid reactive material. This approach allows the heat to be delivered quickly; but places a constriction on the overall cycle efficiency that is difficult to overcome. The fundamental drawback of presently employed designs is that by directly irradiating the solid reactive material, the surface area used for radiative absorption is equal to the surface area available for the chemical reactions. This places a bottleneck on the total thermal to chemical energy conversion efficiency that can be obtained, due to heavy thermal losses associated with radiation.

### SUMMARY OF THE INVENTION

Various deficiencies in the prior art are addressed through the invention of a method and system for solid reactant based thermochemical process. The method includes the steps of identifying a metal oxide or solid reactant having a crystal structure associated with a characteristic state of high temperature engendering creation of oxygen vacancies; heating the metal oxide to the high temperature corresponding to said state of oxygen vacancies; cooling said solid reactant to a temperature conducive to water splitting reaction; introducing steam to react with the solid reactant to thereby re-oxidize said solid reactant producing hydrogen gas; and reheating the re-oxidized solid reactant to a reduction temperature completing the process of solid based reactant thermochemical solar power generation.

The system includes one or more processors adapted to configure a solar absorption system configured for converting electromagnetic energy to thermal energy; a thermochemical system for converting the thermal energy to chemical energy; a gas storage system for storing product gases; and a power generation system for processing the stored product gases into electrical power.

### BRIEF DESCRIPTION OF THE DRAWINGS

The teachings of the present invention can be readily understood by considering the following detailed description in conjunction with the accompanying drawings, in which:

FIG. 1 depicts an exemplary power generation system according to one embodiment;

FIG. 2A depicts the lattice structure of the solid reactant according to one embodiment;

FIG. 2B depicts the phase diagram of the solid reactant according to one embodiment;

FIG. 3A illustrates an overview of the thermal and chemical processes involved in a thermochemical water splitting cycle;

FIG. 3B graphically illustrates thermochemical step 1 (TCS1) according to one embodiment;

FIG. 3C graphically illustrates thermochemical step 2 (TCS2) according to one embodiment;

FIG. 3D graphically illustrates thermochemical step 3 (TCS3) according to one embodiment;

FIG. 3E graphically illustrates thermochemical step 4 (TCS4) according to one embodiment;

FIG. 4 depicts a typical reaction chamber showing how the pipes converge to its pump, which then distributes the flow of a working fluid to the solid reactant coated pipes (SRCP) inside the reaction chamber;

FIG. 5 depicts the top view of the reaction chamber array showing the network of pipes that connect each reaction chamber with all others;

FIG. 6 depicts a flow diagram of a method for solid based reactant thermochemical solar power generation according to an embodiment; and

FIG. 7 depicts a high-level block diagram of a computing device suitable for use in implementing various functions described herein.

### DETAILED DESCRIPTION

The invention will be primarily described within the context of particular embodiments; however, those skilled in the art and informed by the teachings herein will realize that the invention is also applicable to other technical areas and/or embodiments. For example, the invention could be applicable to a number of thermochemical cycles used for a variety of purposes. The invention is described herein with respect to the specific context of solar driven thermochemical water splitting.

Generally speaking, the present invention is a system design for solar driven thermochemical cycles. In a solar driven thermochemical water splitting system, energy is collected from the sun in the form of light via a heliostat or other solar collector. It is then converted to thermal energy when the reflected light is focused onto an absorber medium at the focal point of the heliostat. The thermal energy that is absorbed is then primarily used to supply heat for an endothermic chemical reaction and can also be used in other preheating/reheating processes within the cycle. The thermal energy is converted to chemical energy through the heat driven chemical reaction(s). The chemical energy can be stored indefinitely without parasitic leakage.

The proposed cycle has five important advantages over other alternative energy technologies: (1) Energy can be buffered and stored indefinitely in simple pressure vessel gas storage; (2) The thermal to chemical energy conversion process can reach high efficiency; (3) The system is highly scalable, and can be used for utility scale (MW) power production at both peak and base loading conditions; (4) There is no net chemical footprint on the environment; and (5) Unlike thermal storage, the claimed embodiments can be efficient at less than 10 MW/hr and storage scales can be continually expanded in a modular way.

The design is primarily disclosed in the context of solar driven thermochemical water splitting where the primary reactant is in the solid phase. Although the focus here is on water splitting embodiments; however, other embodiments can be optimized for several other thermochemical processes, such as the conversion of carbon dioxide and water into syngas or CO₂ captured from flue gas.

The instant design contemplates a more optimal solar driven thermochemical system, which decouples the two processes. Accordingly, the approach allows the photo to thermal energy conversion at the absorber to be controlled and optimized separately from the thermal to chemical energy conversion processes within the reaction chamber. Further, the design allows for optimization according to six (6) guiding design principles, which are key intellectual insights that have not been previously realized in other designs. Namely,

1. The total chemical output of the cycle is proportional to the amount of solid reactant being cycled. It is therefore advantageous to maximize the amount of material being cycled, and also the surface area available for the reactions to take place. The amount of heat lost due to re-radiation to the atmosphere depends on the amount of surface area that is exposed (aperture size) to the atmosphere, where the sunlight is concentrated. It is therefore advantageous to minimize this area, so that losses are minimized and efficiency is maximized. Considering these two issues, it is therefore advantageous to decouple the amount of surface area needed for absorbing solar radiation from the surface area associated with the solid reactant. The surface area needed for solar radiation absorption must be finite and as a result re-radiation to the atmosphere cannot be completely suppressed. The solid reactant, however, can be completely surrounded by insulation to reflect radiation and minimize heat losses due to conduction and convection. The invention described herein decouples the surface area needed for radiation absorption from the surface area involved in the chemical reactions by using a working fluid (heat transfer fluid that remains liquid at high temperature) to transfer the heat from the solar absorber to the solid reactant. This decoupling of the solar absorption and thermochemical processes allows each portion of the cycle to be optimized separately. Additionally, the present design can also allow for pressure recuperation to minimize the work required to conduct the two reactions at different pressures.

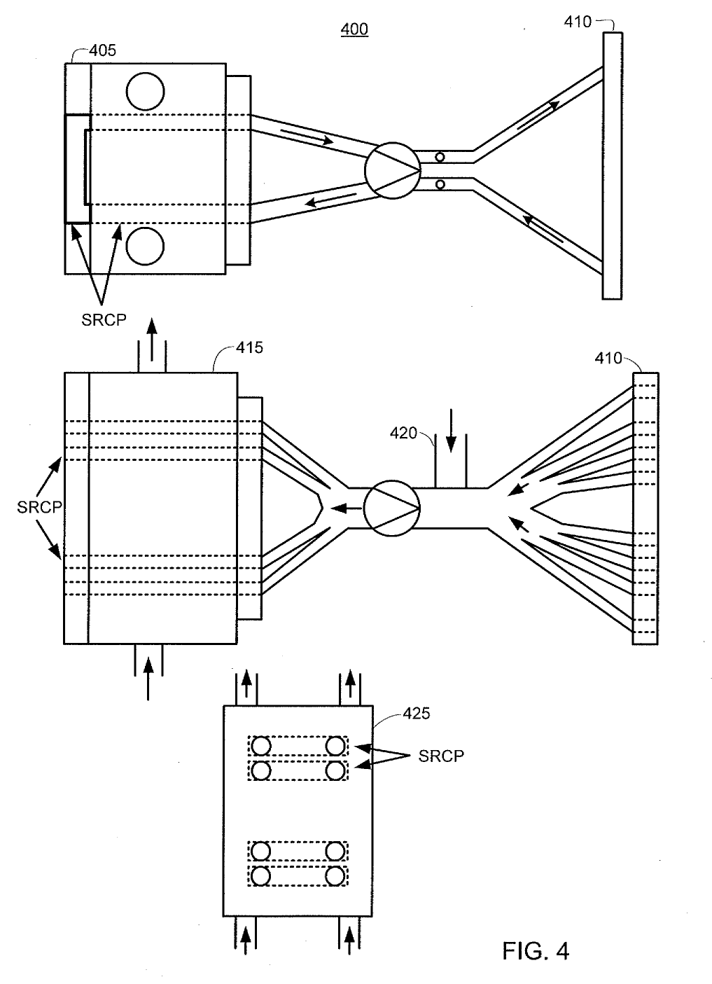

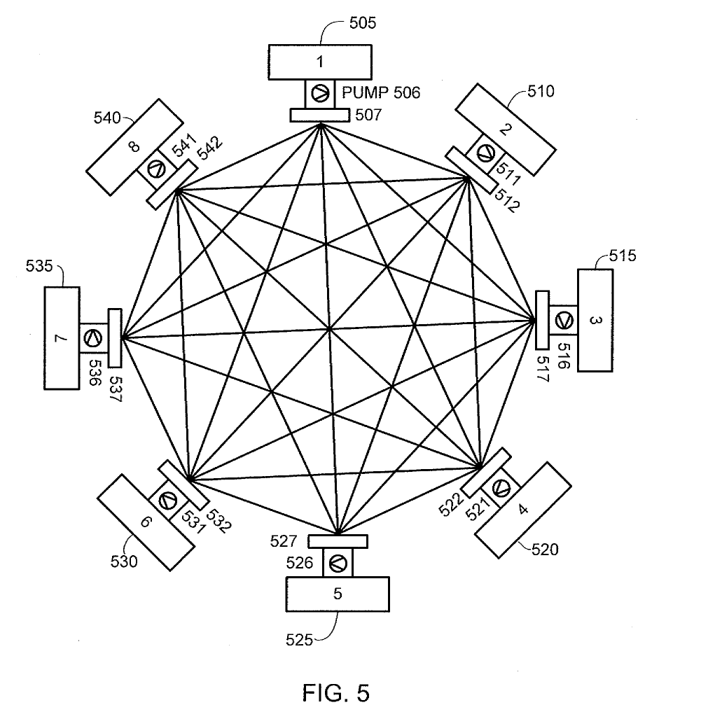

2. To obtain high efficiency in a solar driven thermochemical cycle, the thermal energy that is absorbed/captured must be utilized effectively to minimize heat loss to the surroundings. One key step shown in FIGS. 4c and 4e, is the recovery of heat as the solid reactant is cooled to the lower temperature for the water splitting step. At high temperatures, radiative heat transfer becomes increasingly dominant; however, it is always present even when conductive and convective channels for heat transfer are available. Therefore, direct physical contact between the two streams of solid reactant would be optimal, because radiative heat transfer will also assist. This can be achieved by using a working fluid to transfer heat between the solid reactant in the up (heating) and down (cooling) streams. A design that facilitates conductive/convective heat transfer will be more optimal than a design that relies on radiative heat transfer alone.

3. Thermochemical reactions can be strongly impacted by the temperature and pressure of the gas species. It is therefore advantageous to employ a system design that allows the gas flow during one reaction (thermal reduction) to be controlled independently of other reactions (water splitting). Using an array of sealed reaction chambers allows the gas temperature and pressure to be controlled during each reaction separately.

4. Thermochemical cycles can be most efficient when certain reactions are carried out at the highest temperatures possible. High temperatures, however, can induce significant safety risks. When machines with moving parts are maintained at high temperatures or are cycled between temperature extremes the likelihood of mechanical failure increases. Thus, for safety and reliability concerns, it is advantageous to avoid having high temperature moving parts. In the present invention, moving parts typically associated with thermomechanical cycles are avoided in favor of an extensive network of permanent piping and seals. Thus, the only moving parts are contained in the fluid pumps and computer controlled valves that drive and control the various flows within the system to transport thermal energy and separate the reactants and products. The cyclic nature of the thermochemical processes in the present design arises from the cyclic sequence of opening and closing of computer controlled valves mounted inline with each pipe.

5. It is advantageous to employ a design that allows for dynamic local temperature, pressure and composition measurements. This in turn allows the reactions to be monitored so that incomplete reactions are avoided and feedback loops can be used to automate the response of internal processes. By using an array of individual sealed reaction chambers the present invention allows for such measurements and control.

6. To maximize thermochemical efficiency, it is advantageous to cycle the maximum amount of reactant material as possible. This means that the solid reactant should be packed as densely as possible maximizing the reactive surface area to volume ratio, while simultaneously minimizing the area in thermal contact with the surroundings. Minimizing the area that must be insulated keeps conductive and convective heat losses to a minimum. For illustrative purposes, only 8 solid reactant coated pipes (SRCP) are shown. Other embodiments are contemplated that would comprise fewer or more densely packed SRCP. Such arrangement would minimize thermal losses due to conduction and convection in comparison to the amount of chemical output. Further, the volume that can be occupied by reactant gas species is minimized. These reactant gases can increase the transient response time of each reaction and can reduce the total amount of gas that must be heated and separated, and therefore translates to additional energy savings. Furthermore, since the total output is proportional to the volume of material being cycled, and the heat losses are proportional to the area exposed to the environment, it is advantageous to maximize the volume/surface area ratio for the reactant to the reactor. This ratio generally increases with the overall system size, therefore the present invention can become more efficient when scaled up to larger sizes. Other embodiments are contemplated where the means of introducing the reactant and product gases are introduced is controlled and optimized such that the best flow pattern is obtained.

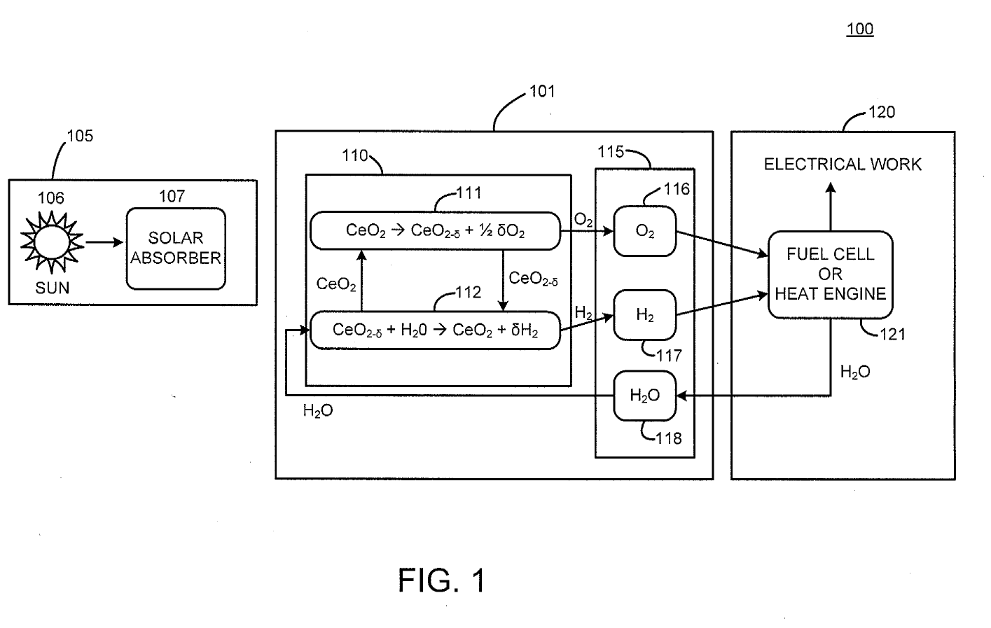

FIG. 1 depicts an exemplary power generation system according to an embodiment. Specifically, FIG. 1 depicts a reaction chamber 101 and four (4) distinct subsystems; namely, solar absorber subsystem 105, thermochemical subsystem 110, gas storage subsystem 115 and power generation subsystem 120. FIG. 1 further depicts the 4 subsystems (105, 110, 115 and 120) showing the thermal input and electrical output of the cycle, along with the various chemical inputs and outputs to the various subsystems. The chemical inputs and outputs show that the system takes sunlight as input and converts the sun light to electrical output without any chemical input from or output to the environment. The major benefit of using subsystem 2 (thermochemical system 110) as opposed to other forms of energy conversion, is that the thermochemical energy conversion process allows the energy to be stored chemically and buffered in subsystem 3 (gas storage system 115) so that electricity can be produced at anytime and can adapt to different electrical loads on the utility grid.

In one embodiment, solar absorption system 105 also referred to herein as Subsystem 1 can be engineered in what is often referred to as a “power tower” configuration.

In various embodiments, subsystem 105 converts the sun light 106 (electromagnetic energy/photons) to thermal energy (phonons) by raising the temperature of absorber 107. In one embodiment, absorber 107 is designed to be highly absorbing of the incident light. Inside the absorber, the high temperature working fluid flows, carrying the heat away from the absorber where it is later delivered to subsystem 110. The technology involved in subsystem 1 (solar absorption system 105) is well established and need not be discussed in further details here. It is however, noted that a temperature of about 560° C. is attained using the well established technology.

In one embodiment, subsystem 110 also referred to herein as Subsystem 2 is the thermochemical system. In various embodiments, subsystem 110 converts the thermal energy (transferred from the absorber to the working fluid) to chemical energy, which can be stored as fuel and used whenever desired and at whatever rate is required. In this embodiment, the thermochemical subsystem is discussed in the context of splitting water (H₂O→H₂+½O₂). Although described within the context of splitting water, it will be appreciated that with minor adjustments the embodiment could also be used for other reactions. Thermochemical system 110 takes as input, heat from the solar absorber as well as water stored in subsystem 3 (i.e., the gas storage system). The outputs of subsystem 2 are H₂ and O₂ gas, which are stored in subsystem 3. Thermochemical system 110 uses the working fluid, heated by the solar absorber (subsystem 1), to heat a solid reactant and drive an endothermic reaction 111 (thermal reduction, i.e. CeO₂+heat→CeO_{2-δ}+½δO₂)—which creates oxygen vacancies in the lattice of the solid reactant or metal oxide. Vacancy creation in the lattice of a material is well known in the art and need not be further described here. This now reduced solid reactant (CeO_{2-δ}) is then cooled in process 112, and the rejected heat from process 112 is carried away by the working fluid to be used elsewhere in the cycle. Once at a lower temperature, steam 118 is introduced and the tendency for the solid reactant to reoxidize drives water molecules to dissociate (the vacancies are refilled with oxygen atoms from water molecules) CeO_{2-δ}+δH₂O→CeO₂+δH₂. This reaction generates hydrogen gas 117. The now reoxidized solid reactant is then recycled, by reheating it with rejected heat, via the working fluid from other solid reactant being cooled—thereby forming a heat exchanger.

In various embodiments, subsystem 115 also referred to herein as subsystem 3 is the gas storage system. The product gases (H₂ 117 and O₂ 118) from the thermochemical system 110 (subsystem 2), can be stored in standard pressure vessels and used whenever needed at whatever rate is required. Pressure vessel (gas storage tank) technology is very well established and therefore the gas storage system 115 (subsystem 3) will not be discussed in detail. It is acknowledged, however, that pressure vessel gas storage may be sub-optimal and other hydrogen storage methods (i.e., metal hydrides) may be advantageous. Nonetheless, simple pressure vessel gas storage is considered in the present invention for simplicity, since the technology is robust and well established.

In various embodiments, subsystem 120 also referred to herein as subsystem 4 is the power generation system. Subsystem 4 (120) takes as inputs H₂ 117 and O₂ 116 gas stored in subsystem 3 and outputs electrical power and H₂O, which is then stored in a separate tank in subsystem 3. The output H₂O stored in subsystem 3 can be recycled as input to subsystem 2, thus forming an entirely closed looped system, whereby no chemicals are released to the environment. The net result of the entire cycle (subsystems 1-4) is a system that ultimately converts sunlight into electricity, where the energy can be buffered and stored indefinitely as H₂ and O₂ in subsystem 3. Several options exist for converting chemical energy into electricity. In one embodiment, subsystem 4 could contain a fuel cell, which can convert the chemical energy into electricity at high theoretical efficiency or a heat engine or a combination of both. The advantage of using a fuel cell (i.e., solid oxide fuel cell operating at about 500-900° C.) is its potentially higher efficiency, which when combined with a heat engine such as a steam based Rankine cycle (which uses the high temperature waste heat as input) can achieve the highest fuel to electricity conversion efficiencies. Industrial scale fuel cell technology, however, is still under development and the cost of such devices must be reduced in order for them to be competitive. In another embodiment, a heat engine is used. C Heat engine is currently cheaper and is a very well established technology.

One major benefit of this cycle (subsystems 1-4) is that both H₂ and O₂ are stored in subsystem 3 and serve as inputs to subsystem 4. As a result, combustion of H₂ need not use air from the environment, which contains ˜70% nitrogen. During combustion processes that use air from the environment, such as internal combustion engines in automobiles and conventional power plants, nitrogen oxides (NOₓ) gases are generated in the exhaust and are harmful. Many of the difficulties associated with reducing NOₓ gases in combustion exhaust, however, can be circumvented here, by simply using the pure O₂ stored in subsystem 3 through oxy-combustion.

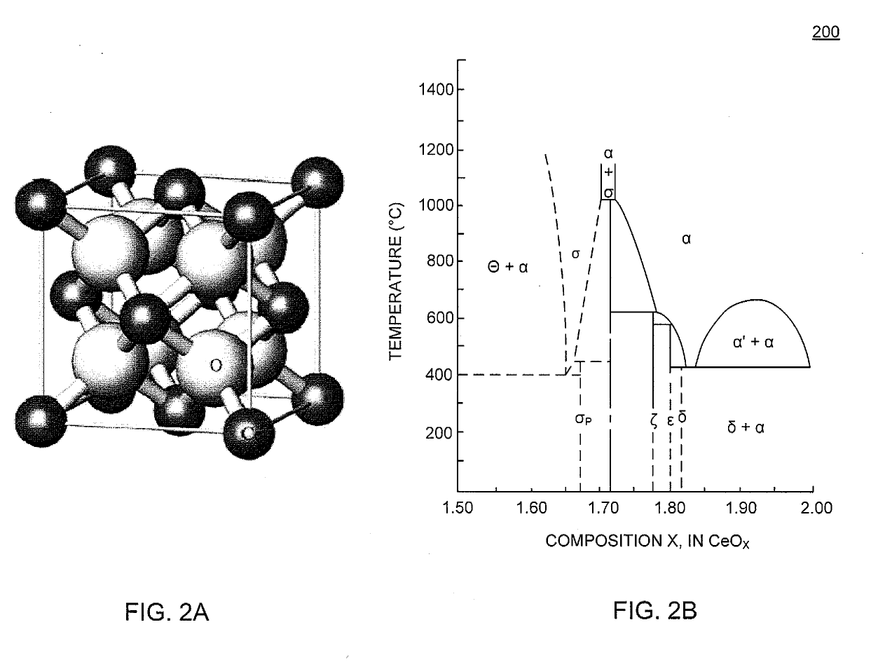

FIG. 2A depicts the lattice structure of the solid reactant according to one embodiment. Illustratively, the structure depicted falls in the fluorite category. Other materials with similar characteristics may be used. In this embodiment, ceria is used as the solid reactant material. Ceria is a useful material for such an application for four major reasons three of which are discussed below in reference to FIG. 2A. First, ceria can support large off-stoichiometry CeO_{2-δ}δₘₐₓ˜0.25 while remaining in the fluorite structure. This property is not necessarily peculiar to ceria, but is notable and is responsible for its ability to be cycled many times between reaction steps 1 & 2 (TCS1 & TCS 2) without degradation. Other materials such as perovskites may also exhibit some of the same features.

FIG. 2B depicts the phase diagram of the solid reactant according to one embodiment. As stated above, the remaining three reasons for using ceria follow. Second, ceria remains in the fluorite crystal structure, from room temperature to well above 1500° C., which allows it to be cycled repeatedly without changing phase. The only changes at lower temperatures as shown in FIG. 2B are the formation of ordered vacancy phases. Third, the enthalpy of reduction for ceria is ˜4 eV, which makes it significantly reducible at 1500° C. (reaction step 1) and provides a strong driving force for reoxidation during reaction step 2. Fourth, ceria has a positive entropy of reduction. This property is peculiar to ceria and it minimizes the required difference in temperature needed to cycle between reaction steps 1 & 2.

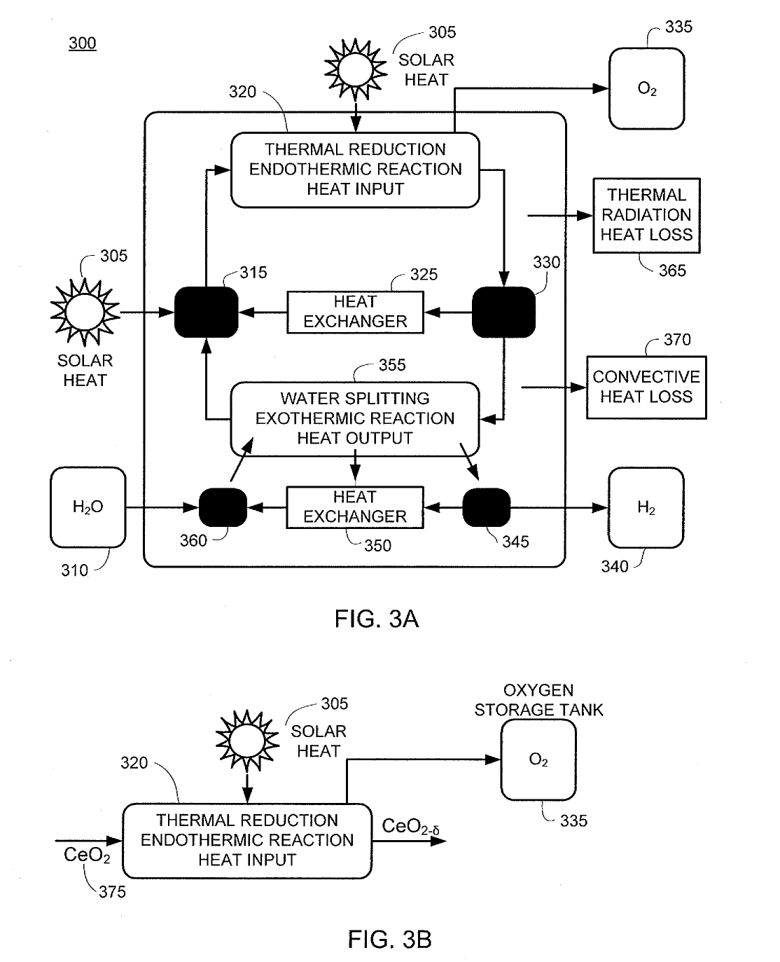

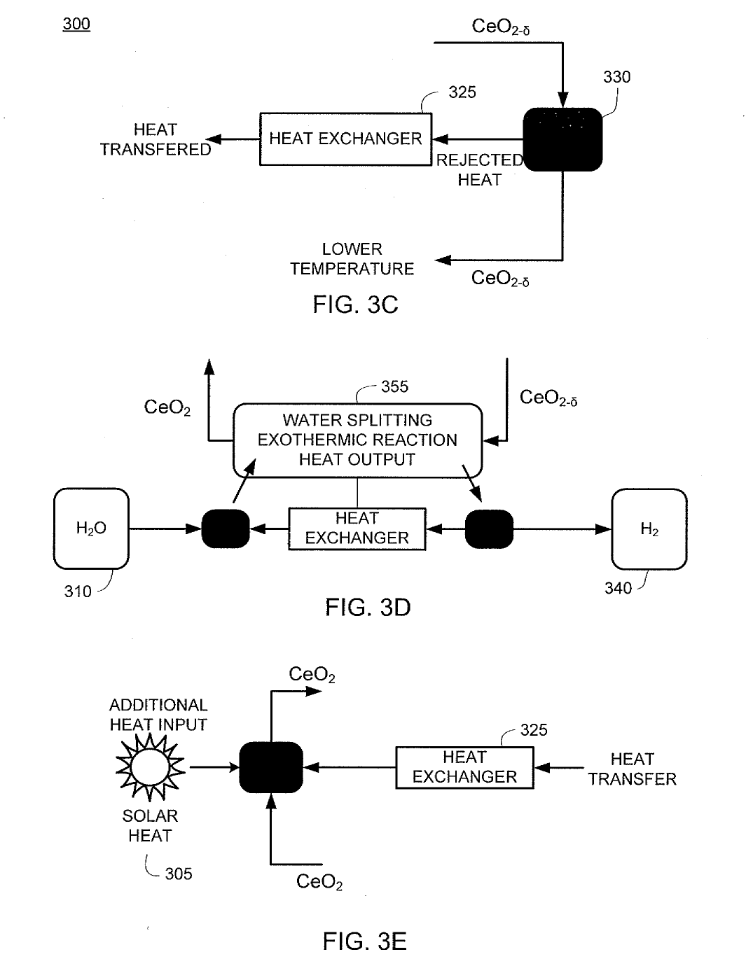

FIG. 3A depicts an overview of the thermal and chemical processes involved in a thermochemical water splitting cycle, using non-stoichiometric ceria (CeO_{2-δ}), with heat recovery indicated by the pictures of heat exchangers 325 and 350. Specifically, FIG. 3A shows an outline of the thermal and chemical processes involved in a solar driven thermochemical water splitting cycle. In one embodiment, the cycle shown in FIG. 3A is a two-step thermochemical cycle based on a reduced metal oxide, such as ceria (CeO_{2-δ}). In various embodiments, materials equivalent to ceria (CeO_{2-δ}), i.e., materials that exhibit similar properties as ceria are used.

The term non-stoichiometric ceria (CeO_{2-δ}) refers to metal oxide material ceria where the quantity δ implies the presence of a significant amount of oxygen vacancies in the crystal lattice. These oxygen vacancies are created during thermochemical step 1 (TCS1) the thermal reduction step, and are refilled by the oxygen atoms contained in water (H₂O) during thermochemical step 3 (TCS3), the water splitting step. The decrease in energy or increase in entropy associated with refilling the oxygen vacancies is the driving force for the water splitting reaction. It will be appreciated that the steps may be implemented in any sequence.

It should be noted that the temperature at the start of each stage is equivalent to the temperature at the end of the previous stage. The temperature at the end of each stage is the average temperature of the primary reaction chamber along with the two other chambers it interacted with during that stage. During the thermal reduction step (TCS1), the reaction chamber is assumed to equilibrate with the working fluid from the solar absorber at the highest temperature. The working fluid can be a liquid metal such as tin or aluminum, which remain in the liquid phase throughout the different phases of the cycle.

FIG. 3B graphically illustrates thermochemical step 1 (TCS1). The cycle begins by heating metal oxide 375 to a high temperature in Thermal Reduction Endothermic Reaction Heat Input 320. Specifically, solid reactant 375 (CeO₂) undergoes the first reaction at high temperature, where solid reactant 375 is thermally reduced (CeO₂+heat CeO_{2-δ}+½δO₂). In one embodiment the high temperature ranges from ˜1500°-1800° K. In various embodiments, the high temperature is determined according to the solid reactant used and the overall reaction of interest. The O₂ gas reaction product can be cooled (the rejected heat can be used for preheating or reheating elsewhere in the cycle) to room temperature and stored in a pressure vessel in subsystem 3. The oxygen partial pressure is simultaneously reduced. Oxygen vacancies are created in the solid reactant in the process (reduced metal oxide) [CeO₂+heat CeO_{2-δ}+½δO₂] and oxygen gas 335 is removed so that the solid reactant will not re-oxidize upon cooling. The reduced solid reactant continues within the cycle to thermochemical step 2 (TCS2).

FIG. 3C graphically illustrates thermochemical step 2 (TCS2). Specifically, the cycle continues with solid reactant CeO_{2-δ} being cooled in 330 exchanging heat via heat exchanger 320 using a working fluid. The rejected heat is used to warm more solid reactant (see TCS4) in preparation for the reduction step (TCS1). The heat exchange continues as the solid reactant approaches the temperature needed for the water splitting reaction. In one embodiment the low temperature ranges from (˜800°-4000° K). In various embodiments, the low temperature is determined according to the solid reactant used. TCS2 is a purely thermal step (no chemical changes) where solid reactant is cooled from the high temperature to a lower reaction temperature.

FIG. 3D graphically illustrates thermochemical step 3 (TCS2). TCS3 is a thermochemical step, where water is split into H₂ and O₂, where the O₂ reoxidizes the solid reactant (CeO_{2-δ}+δH₂O→CeO₂+δH₂). The exothermic heat of reaction along with the gaseous H₂ reaction product can be used to preheat the steam, via heat exchanger. The reoxidized solid reactant (CeO₂) then continues within the cycle to thermochemical step 4 (TCS4). Specifically, water is taken from a reservoir (water storage tank 310) in subsystem 3, heated, and allowed to react with the reduced solid reactant in the Water Splitting Exothermic Reaction Heat Output 355. As the solid reactant approaches the temperature required for the water splitting reaction steam is introduced and reacts with the reduced metal oxide to re-oxidize it. In one embodiment the temperature required for the water splitting reaction ranges from (˜800°-1000° K). In various embodiments, the temperature required for the water splitting reaction is determined according to the solid reactant used.

In this phase of the process, the presence of the oxygen vacancies within the solid reactant serves as a driving force for the reaction. As a result, water molecules disassociate so that the oxygen vacancies in the solid reactant can be refilled by the oxygen atoms in water. During this process, hydrogen atoms combine to form H₂ and desorb from the solid reactant surface as H₂ gas 340. The net reaction is then CeO_{2-δ}+δH₂O→CeO₂+δH₂, where the oxygen vacancies in CeO_{2-δ} are refilled by the oxygen atoms obtained from disassociating water molecules. The product H₂ is then removed with a sweep gas, such as excess H₂O, which can be separated elsewhere by condensing H₂O into the liquid phase (˜300-500K) depending upon the pressure). The product H2 gas can then be stored in subsystem 3 (gas storage system).

FIG. 3E graphically illustrates thermochemical step 4 (TCS4). TCS4 is a purely thermal process, where the temperature of the solid reactant CeO₂ is raised from the lower reaction temperature (800°-1000° K) to the high temperature (1500°-1800° K). The output of TCS4, reoxidized CeO₂, continues to TCS1, where the cycle begins again—forming a chemically closed loop, where the net chemical reaction is (H₂O→H₂+½δO₂). Specifically, the solid reactant (CeO₂) is reheated. A major portion of the heat input is taken from the heat rejected from other solid reactant undergoing TCS2. However, due to imperfect heat exchange (2nd law of thermodynamics), fully reheating the solid reactant will require supplementary heat, which is taken from the solar absorber.

FIG. 4 depicts reaction chamber 400 comprising top view 405, side view 415, front view 425 and piping panel 410) showing how the pipes converge to its pump, which then distributes the flow of the working fluid to the solid reactant coated pipes (SRCP) inside the reaction chamber. Specifically, piping panel 410 is where all the pipes between a single reaction chamber and all other reaction chamber converge. Inside the piping panel, there are fixtures, permanent seals and computer controlled valves that are not shown. The computer controlled valves determine the pipes through which the working fluid circulates. The valves are toggled on and off at different points in the cycle for heat recovery purposes.

Top view 405 of reaction chamber 400 shows in more detail how the pipes converge to its pump, which then distributes the flow to the solid reactant coated pipes (SRCP) inside the reaction chamber. Arrows indicate the direction of the working fluid flow circulating between the reaction chambers.

Side view 415 of reaction chamber 400 shows its pump and how the 8 stacks of inlet and outlet pipes converge onto its pump. The pump then distributes the flow to the four layers of SRCP inside the reaction chamber. The red arrow indicates working fluid pumped directly from the solar absorber (1800° K), which is used during the high temperature reduction (step 1). Arrows indicate gas flow pipes that transport the sweep, reactant and product gases in and out of the reaction chamber.

Pipe orifice 420 provides an entry point for working fluid heated in the solar absorber. A computer controlled valve is turned on during the reduction step (TCS1) so that the SCRP is heated to the highest temperature.

Front view 425 of reaction chamber 400 shows the four layers of the SRCP being used.

FIG. 5 depicts an array of individual reaction chambers 500. Each reaction chamber (505, 510, 515, 520, 525, 530, 535 and 540) contains pipes within it that are coated with the solid reactant material and are thus termed solid reactant coated pipes (SRCP). The convention used to designate a pipe connecting two reaction chambers is denoted as x:y where x represents the source chamber and y represents the destination 1:8, 8:1 connects reaction chamber 1 to reaction chamber 8 and represents pipe 1:8 and pipe 8:1. As indicated in the 6 design criteria, the present design separates the thermal processes and chemical processes in an elegant way, by using sealed reactors. With the solid reactant coated on the outside of the SRCP that run through the reaction chamber walls (see FIG. 4), all chemical processes occur on the outer surfaces of these pipes within the permanently sealed chamber. The thermal processes are achieved by circulating a working fluid through the inner walls of the SRCP, where convection from the working fluid transfers heat to the inner walls of the SRCP, which is then conducted through the pipe walls to the solid reactant coated on its outer walls. In various embodiments, the pipe walls are as thin as possible to minimize thermal resistance. As a result, chemical processes occur on the outer walls of the SRCP while thermal processes occur on the inner walls of the SRCP. In other embodiments, more optimal SCRP geometries are used.

The heat recovery (heat exchange) between TCS2 and TCS4 is achieved by circulating the working fluid from one reaction chamber to other reaction chambers through a network of pipes. When the fluid is circulated, heat is exchanged between the solid reactant contained within the reactors until they approach thermal equilibrium. The circulation of the working fluid can be dictated by computer controlled valves on each of the pipes within the network. The sequence of which valves are opened and closed at different time intervals, controls the cyclic nature of the thermochemical processes and avoids moving parts associated with moving the solid reactant itself. In one embodiment, the design comprises 8 reaction chambers. In other embodiments, any suitable number of arrays of reaction chambers may be used. Further, in one embodiment N reaction chambers are assembled in a concentric arrangement. In other embodiments, other assembly geometries are also possible.

Each of the N reaction chambers has pipes (545) connecting it to each of the other N−1 reaction chambers. A plurality of pipes 545 runs between each individual reaction chamber and all other N−1 reaction chambers. Although the top view shows many places where the pipes cross, it is important to note that none of the pipes actually intersect each other within the circle. The pipes do converge onto a piping panel in front of each reaction chamber, but the flow in each pipe is distinct and does not mix with the flow in any other pipes, even though it appears to cross other pipes in FIG. 5. This non-intersection of the pipes can be achieved by simply layering the pipes at different heights above ground. There are a number of geometric variations for how this can be accomplished. In one embodiment, the pipes are stacked in 8 distinct layers, where layer 1 is located at the top of the stack (highest from the ground) and layer 8 is at the bottom (closest to the ground). The pipe naming convention corresponds with the direction of flow, so that 1:8 indicates a pipe carrying fluid from reaction chamber 1 to reaction chamber 8 and 8:1 carries working fluid from reaction chamber 8 back to reaction chamber 1. The two pipes together allow the working fluid to be circulated between the reaction chambers.

A heat transfer/working fluid (e.g., tin, aluminum) that remains liquid at the highest temperatures flows within all the pipes shown. This working fluid carries the heat stored in the contents of one reaction chamber to the contents of another reaction chamber. Each set of pipes has a computer controlled valve that determines whether or not the working fluid will flow or remain stagnated. The valves (not shown) are closed (no fluid flow) in all the pipes at all times, except when they are opened between two reaction chambers to allow for circulation and heat transfer. Each reaction chamber also contains another pipe that connects to the fluid being directly heated by the solar absorber. This fluid is used during the reduction step (TCS1) to heat the contents of the reaction chamber to the target reduction temperature. Each reaction chamber also has an inlet and outlet channel so that sweep, reactant and product gases can be added/removed from the reaction chamber. Each reaction chamber has a number of pipes running through it that are rigidly connected to its walls. These pipes are coated with the solid reactant material (e.g., CeO_{2-δ}) and are therefore termed solid reactant coated pipes (SRCP). The working fluid can flow through these SRCP to heat the reactant material from the inside, transferring heat to the inner pipe walls via convection and transferring heat to the solid reactant through the pipe wall via conduction. The sweep and reactant gases can enter the reaction chamber and interact directly with the solid reactant on the outer walls of the SRCP. The flow through all pipes is driven by an array of pumps. The way in which these pumps are arranged is flexible. In one embodiment, a configuration whereby each reaction chamber has its own pump (506, 511, 516, 521, 526, 531, 536 and 541) and there are also assumed pumps (not shown) that drive the sweep, reactant and product gas flows, as well as pump(s) (not shown) to drive the working fluid to the solar absorber and into each reaction chamber during its reduction step (TCS1). It is noted that all pipes are heavily insulated with radiation and convective shielding to minimize thermal loss to the surroundings. In addition, the valves on each set of pipes are computer controlled and determine whether or not the working fluid will flow. The opening and shutting off of these valves require minimal energy and can be automated through actuators while controlled by an external computer or programmed circuit. It is through the sequence of valve openings and closings that the cycle repeats and one advantage of the present design is that the timing sequence can change dynamically based on feedback from each reaction chamber via different cycle phases.

In the present design, TCS1 of the process shown in FIG. 3, is accomplished by pumping high temperature working fluid through the SRCP of one reaction chamber, delivering heat to the solid reactant, which is coated on the pipe's outer walls. Simultaneously, the partial pressure of oxygen can be lowered by either removing oxygen directly with a vacuum pump, or using a sweep gas such as Argon or H₂O (H₂O is essentially inert with respect to CeO_{2-δ} at such high temperatures (i.e., no water splitting). In the present design a sweep gas (H₂O) is assumed and can flow in and out of the sealed reaction chamber through the pipes, driven by a gas pump (not shown). During step 2 when the solid reactant in one reaction chamber is cooled, working fluid is circulated between it and other reaction chambers in the circle that contain solid reactant at a lower temperature. This fluid driven heat exchange between individual reaction chambers occurs through the network of pipes shown in FIG. 5, by sequentially switching valves accordingly. The circulation of working fluid between two reaction chambers in the circle continues until the content of the two reaction chambers approach thermal equilibrium (the same temperature). A major advantage of the present design is that the time it takes to approach equilibrium between two reaction chambers can be controlled by the fluid flow rate (more pumping power=faster heat exchange). Therefore, if the heat transfer processes are the rate limiting portion of the cycle, the flow rate can be optimized to yield maximum total system efficiency. After the thermal equilibrium between two reaction chambers is achieved, the valves switch again allowing fluid to circulate with the next reaction chamber in the circle.

### Thermochemical Cycle Sequence.

The following sequence of 8 stages describes how the reaction chamber 505 would traverse TCS1-TCS4. At the beginning of the cycle, reaction chamber 8 (540) has just finished its reduction step (TCS1) at 1800° K by receiving working fluid pumped from the solar absorber. At this stage reaction chamber 1 (505) is preparing for the reduction step (TCS1) and exchanges working fluid with reaction chamber 8 (540) via pipes 1:8 and 8:1. This helps to raise the temperature of chamber 1 (505) closer to 1800° K and lower the temperature of reaction chamber 8 (540) so that it can begin cooling towards the low temperature step at 1000° K. At the midpoint of stage 1, after reaction chambers 1 (505) and 8 (540) equilibrate, the valves for pipes 1:8 and 8:1 are closed and reaction chamber 1 (505) begins receiving working fluid from the solar absorber to drive the thermal reduction reaction. By the end of stage 1, reaction chamber 1 (505) has reached 1800° K, the temperature of the working fluid pumped from the solar absorber. At the end of stage 1, the partial pressure of oxygen has also been reduced substantially by using a sweep gas or vacuum pump to remove oxygen from the reaction chamber. Reaction chamber 1 (505) then begins its cool down sequence (stages 2, 3 and 4—TCS2), by exchanging working fluid with reaction chambers 2-7 (510-535) in a predetermined sequence. At each stage the valves between each pair of reaction chambers are opened and working fluid is circulated between the two reaction chambers. For example, at the beginning of stage two, pipes 1:2 and 2:1 are opened so that reaction chambers 1 (505) and 2 (510) can circulate their working fluid. In the second half of stage 2, pipes 1:2 and 2:1 are closed and pipes 1:3 and 3:1 are opened for circulation and so on.

At the beginning of stage 5, reaction chamber 1 (505) begins circulating working fluid again with reaction chamber 8 (540) through pipes 1:8 and 8:1, which just completed its water splitting reaction at 1000° K (TCS3). Half way through stage 5, the valves of pipes 1:8 and 8:1 are closed and reaction chamber 1 (505) is exposed to steam at 1000° K, which starts the water splitting reaction (TCS3). By the end of stage 5 the solid reactant has been re-oxidized and it has equilibrated with the 1000° K flow of reactant steam. During stages 6-8, reaction chamber 1 (505) is reheated (TCS4) in preparation for the high temperature reduction step (TCS1).

In other embodiments, a feedback loop may be implemented to control the cycle thereby taking into account periods when solar energy is either diminished (e.g., cloudy days) or absent (hurricane). Such feedback loop would use temperature, pressure and chemical composition of the fluid adaptively. In such embodiments, conversion of light to thermal energy from the conversion of thermal energy to chemical energy is decoupled; therefore, a control system can be used to buffer energy at various points in the cycle. This arrangement is implemented in response to intermittent sun light, intermittent output or in response to demand/load variations. The control is executed by varying the cycle time, temperature, pressure, inlet and outlet gases, the rate of heat recuperation and the like.

Other embodiments provide for storing or buffering H₂ for use over longer period when solar energy is unavailable. The amount of H₂ needed is application or plant specific. However, that amount can be calculated knowing the variables for each application.

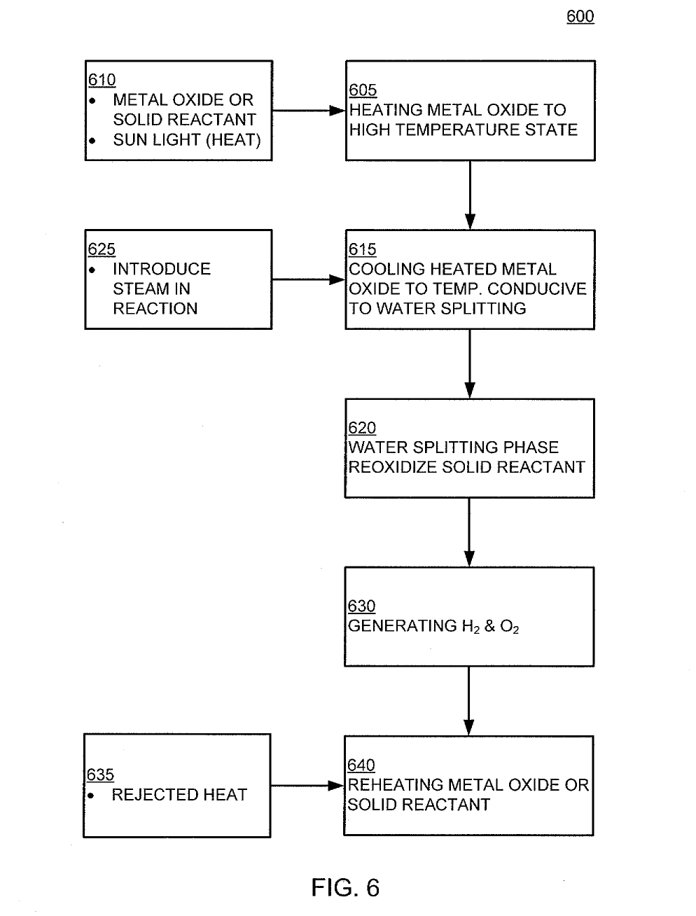

FIG. 6 depicts a flow diagram of a method for solid based reactant thermochemical solar power generation according to an embodiment. The cycle begins at step 605. Metal oxide or solid reactant is heated to a high temperature. The solid reactant (CeO₂) undergoes the first reaction at high temperature, where the solid reactant is thermally reduced (CeO₂+heat→CeO_{2-δ}+½δO₂). In one embodiment the high temperature ranges from ˜1500°-1800° K. In various embodiments, the high temperature is determined according to the solid reactant used. The O₂ gas reaction product can be cooled (the rejected heat can be used for preheating or reheating elsewhere in the cycle) to room temperature and stored in a pressure vessel in subsystem 3. The oxygen partial pressure is simultaneously reduced. Oxygen vacancies are created in the solid reactant in the process (reduced metal oxide) [CeO₂+heat CeO_{2-δ}+½δO₂] and oxygen gas 335 is removed so that the solid reactant will not re-oxidize upon cooling. The reduced solid reactant continues within the cycle to thermochemical step 2 (TCS2).

At step 615, the cycle continues with solid reactant CeO_{2-δ} being cooled in exchanging heat via heat exchanger using a working fluid. The rejected heat is used to warm more solid reactant (see TCS4) in preparation for the reduction step (TCS1). The heat exchange continues as the solid reactant approaches the temperature needed for the water splitting reaction. In one embodiment the low temperature ranges from (˜800°-1000° K). In various embodiments, the low temperature is determined according to the solid reactant used. TCS2 is a purely thermal step (no chemical changes) where solid reactant is cooled from the high temperature to a lower reaction temperature.

At step 620, water is taken from a reservoir (water storage tank 310) in subsystem 3, heated, and allowed to react with the reduced solid reactant. As the solid reactant approaches the temperature required for the water splitting reaction, steam is introduced and reacts with the reduced metal oxide to re-oxidize the solid reactant. In one embodiment, the temperature required for the water splitting reaction ranges from (˜800°-1000° K). In various embodiments, the temperature required for the water splitting reaction is determined according to the solid reactant used.

In this phase of the process, the presence of the oxygen vacancies within the solid reactant serves as a driving force for the reaction. As a result, water molecules disassociate so that the oxygen vacancies in the solid reactant can be refilled by the oxygen atoms in water. During this process, hydrogen atoms combine to form H₂ and desorb from the solid reactant surface as H₂ gas 340. The net reaction is then CeO_{2-δ}+δH₂O→CeO₂+δH₂, where the oxygen vacancies in CeO_{2-δ} are refilled by the oxygen atoms obtained from disassociating water molecules. The product H₂ is then removed with a sweep gas, such as excess H₂O, which can be separated elsewhere by condensing H₂O into the liquid phase (˜300°-400° K). The product H2 gas can then be stored in subsystem 3 (gas storage system).

At step 630, the temperature of the solid reactant CeO₂ is raised from the lower reaction temperature (800°-1000° K) to the high temperature (1500°-1800° K).

At step 640, the solid reactant (CeO₂) is reheated. A major portion of the heat input is taken from the heat rejected from other solid reactant undergoing TCS2. However, due to imperfect heat exchange (2nd law of thermodynamics), fully reheating the solid reactant will require supplementary heat, which is taken from the solar absorber. The output of TCS4, reoxidized CeO₂, continues to TCS1, where the cycle begins again—forming a chemically closed loop, where the net chemical reaction is (H₂O→H₂+½δO₂).

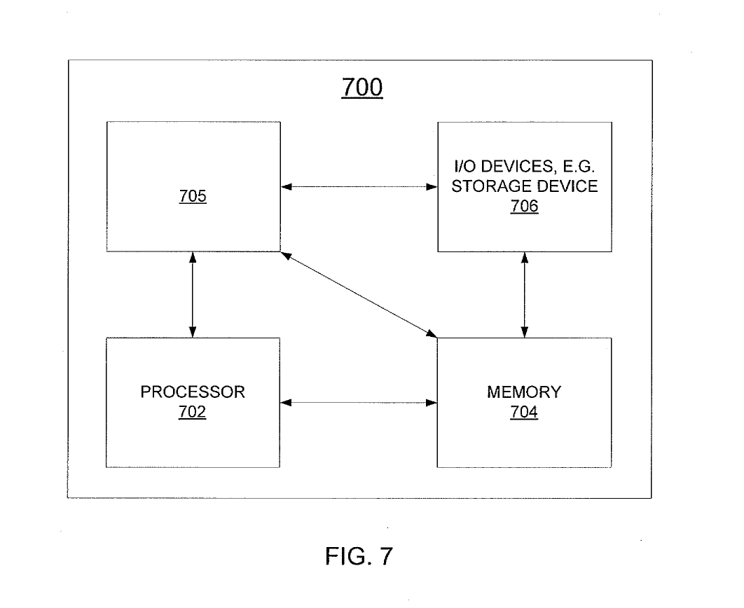

FIG. 7 depicts a high-level block diagram of a computing device suitable for use in implementing various functions described herein.

As depicted in FIG. 7, computer 700 includes a processor element 702, a memory 704 (e.g., 123, random access memory (RAM), read only memory (ROM), and the like), a cooperating module/process 705, and various input/output devices 706 (e.g., a user input device (such as a keyboard, a keypad, a mouse, and the like), a user output device (such as a display, a speaker, and the like), an input port, an output port, a receiver, a transmitter, pressure transducers, flow meters, thermocouples and storage devices (e.g., a tape drive, a floppy drive, a hard disk drive, a compact disk drive, and the like)).

It will be appreciated that the functions depicted and described herein may be implemented in software and/or hardware, e.g., using a general purpose computer, one or more application specific integrated circuits (ASIC), and/or any other hardware equivalents.

In one embodiment, the various processes 705 may be loaded into memory 704 and executed by processor 702 to implement the functions as discussed herein. Thus, various processes 705 (including associated data structures) may be stored on a computer readable storage medium, e.g., RAM memory, magnetic or optical drive or diskette, and the like.

It is contemplated that portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, and/or stored within a memory within a computing device operating according to the instructions. Further, the system may be controlled by a network of computers or similar arrangement.

Although various embodiments which incorporate the teachings of the present invention have been shown and described in detail herein, those skilled in the art may readily devise many other varied embodiments that still incorporate these teachings.

What is claimed is:

1. A reactor comprising:
one or more reaction chambers arranged in a cascade configuration allowing use of ambient air associated with a preceding reaction chamber to be absorbed by the one or more cascaded reaction chambers, wherein the one or more reaction chambers unsynchronously step through a thermochemical cycle while each one of the one or more reaction chambers completes an entire thermochemical cycle.

2. The reactor of claim 1, wherein one reaction chamber outputs H₂.

3. The reaction chamber of claim 2, wherein a different reaction chamber outputs O₂.

4. The reaction chamber of claim 1, wherein the cascade configuration coupling the one or more reaction chambers comprises a plurality of solid reactant coated pipes (SRCP).

5. The reaction chamber of claim 4, wherein ceria (CeO_{2-δ}) is used as a solid reactant or another metal oxide.

6. The reactor of claim 1 wherein a working fluid delivers heating and cooling to the one or more reaction chambers.

7. The reactor of claim 1, wherein the thermochemical cycle is solar driven.

8. The reactor of claim 1, wherein the one or more reaction chambers output CO₂ or syngas.

9. A method adapted for solid based reactant thermochemical solar power generation, said method comprising:
identifying a suitable metal oxide or solid reactant;
heating the metal oxide to the high temperature corresponding to said state of oxygen vacancies;
cooling said solid reactant to a temperature conducive to water splitting reaction;
introducing steam to react with the solid reactant to thereby re-oxidize said solid reactant producing hydrogen gas; and
reheating the re-oxidized solid reactant to a reduction temperature completing the process of solid based reactant thermochemical solar power generation.

10. The method of claim 1, wherein the metal oxide or solid reactant includes ceria (CeO_{2-δ}).

11. The method of claim 1, wherein the characteristic state of high temperature comprises 1500° to 1800° degrees Kelvin (1500°-1800° K).

12. The method of claim 1, wherein the step of heating the metal oxide further comprises reducing the oxygen partial pressure.

13. The method of claim 4, further comprising removing oxygen gas from the reaction thereby preventing the solid reactant from re-oxidizing upon cooling.

14. The method of claim 1, wherein the step of cooling the solid reactant further comprises using the rejected heat to warm more solid reactant.

15. The method of claim 1, wherein the temperature conducive to water splitting comprises 800° to 1000° degrees Kelvin (800°-1000° K).

16. The method of claim 1, wherein hydrogen gas (H₂) is removed with a sweep gas.

17. The method of claim 8, wherein the sweep gas comprises (H₂O).

18. A system adapted for solid based reactant thermochemical solar power generation, said system comprising:
one or more processors adapted to configure:
a solar absorption system configured for converting electromagnetic energy to thermal energy;
a thermochemical system for converting the thermal energy to chemical energy;
a gas storage system for storing product gases; and
a power generation system for processing the stored product gases into electrical power.
